(19) United States
(12) Patent Application Publication
(10) Pub. No.: US 2015/0103530 A1
(43) Pub. Date: Apr. 16, 2015

(54) Lateral Planar Light Emitting Module

(71) Applicant: UNITY OPTO TECHNOLOGY CO., LTD., New Taipei City (TW)

(72) Inventor: Ping-Chen Wu, New Taipei City (TW)

(21) Appl. No.: 14/578,507

(22) Filed: Dec. 22, 2014

Related U.S. Application Data
(63) Continuation of application No. 13/444,920, filed on Apr. 12, 2012.

(30) Foreign Application Priority Data
Dec. 27, 2011 (TW) 100148865

(51) Int. Cl. F21V 7/00; F21V 13/04

(52) U.S. Cl. CPC F21V 7/0066; F21V 13/04; F21Y 2101/02
USPC 362/297

(57) ABSTRACT

A lateral planar light emitting module has a rectangular base plate and a plurality of light emitting diodes, and the light emitting diodes are designed with an array arrangement and installed on both opposite sides of the rectangular base plate respectively, so that a light exit surface opposite to a light projection area with a different intensity produced by the same light emitting diode has an optical path with a different distance after a light source emitted from the light emitting diodes is projected directly or reflected from a reflective micro-structure of the rectangular base plate, and a light emitting effect with a uniform light intensity distribution is achieved on the light exit surface to lower the manufacturing cost and improve the light emitting efficiency effectively.

### CROSS-REFERENCE TO RELATED APPLICATIONS

This application is a continuation of U.S. Ser. No. 13/444,920 filed on Apr. 12, 2012 and entitled “LATERAL PLANAR LIGHT EMITTING MODULE”, now pending.

### BACKGROUND OF THE INVENTION

1. Field of the Invention

The present invention relates to the area of planar light emitting modules, in particularly to a lateral planar light emitting module capable of producing a light emitting effect for a light source of a light emitting diode with uniform light intensity on a light exit surface without requiring a light guide plate structure.

2. Description of the Related Art

Light emitting diode has the features of long life, low power consumption, and high brightness, and thus it is used extensively and plays an important role in different areas including illumination, warning or display, and becomes a first choice of the light emitting source. On the other hand, the light emitting diode has the property of a high directivity, which limits the applicability of the light emitting source in various different applications, and requires an overall structural improvement of the light emitting source. For example, a full-range illumination device is provided to meet the illumination requirements, or a light guide plate is provided to guide a light source of a backlight module of a display and change the light exit path to emit uniform light.

However, the backlight module is used as an example only. Although the light emitting diode is used as the light emitting source to achieve the power-saving, low-pollution and high-color effects and the light and thin design, yet the light guide plate is still a necessary component, particularly for a lateral backlight module. Therefore, the light guide plate plays an important role of a light guide medium while absorbing lots of light energies. As the display requires an increasing larger size, the cost and weight of the display will be increased, which is a disadvantageous manufacturing condition for terminal products. On the other hand, the light guide plate for large displays requires a thinner structure, which causes a more difficult manufacturing process, and a higher manufacturing cost. Therefore, it is a subject for related manufacturers to omit the light guide plate or substituting the light guide plate by another structure while maintaining a uniform planar light emitting effect.

In view of the description above, the inventor of the present invention based on years of experience in the related industry to conduct extensive researches and experiments, and finally provided a lateral planar light emitting module, comprising a rectangular base plate and a plurality of light emitting diodes, and the rectangular base plate has a diagonal falling within a range of 5˜100 cm, and the light emitting diodes are designed with an array arrangement and installed on both lateral opposite sides of the rectangular base plate respectively, such that a light source emitted from the light emitting diodes can be directly projected, or reflected from a reflective micro-structure of the rectangular base plate, and then a light emitting effect with a uniform light intensity is achieved on a light exit surface, wherein the light exit surface opposite to a light projection area with a different intensity produced by the same light emitting diode has an optical path with a different distance and used for substituting a light guide plate used in a conventional backlight module or planar light emitting source to enhance the brightness of an optical film structure, lower the manufacturing cost, and improve the light emitting efficiency effectively.

### SUMMARY OF THE INVENTION

Therefore, it is a primary objective of the present invention to provide a light emitting effect for a light source of a light emitting diode with uniform light intensity on a light exit surface without requiring a light guide plate structure, so that the light source can be applied effectively in a backlight module of a display or in other planar illumination equipments.

To achieve the foregoing objective, the present invention provides a lateral planar light emitting module, comprising a rectangular base plate and a plurality of light emitting diodes, and the rectangular base plate having a diagonal falling within a range of 5˜100 cm, and light emitting diodes being designed with an array arrangement and installed on both opposite sides of the rectangular base plate respectively, so that a light source emitted from the light emitting diodes is projected directly or reflected from the rectangular base plate, and then light emitting effect with a uniform light intensity distribution at a light exit surface is achieved, and the lateral planar light emitting module is characterized in that a strong light emitting area, a secondary light emitting area, a weak light emitting area and a slightly light emitting area are formed sequentially at normal included angles between each of the light emitting diodes and an environmental medium from 0° to 90°, and the rectangular base plate includes at least one reflective micro-structure formed thereon, and when the light source emitted from each of the light emitting diodes has not passed through a reflection path or reflected from the rectangular base plate of the reflective micro-structure, a first light output point p1 emitted from the strong light emitting area onto the light exit surface, a second light output point p2 emitted from the secondary light emitting area onto the light exit surface, a third light output point p3 emitted from the weak light emitting area onto the light exit surface, and a fourth light output point p4 emitted from the slightly light emitting area onto the light exit surface have a distance of Rₚ₁, Rₚ₂, Rₚ₃ and Rₚ₄ from the light emitting diode of the same two-dimensional space respectively, and Rₚ₁>Rₚ₂>Rₚ₃>Rₚ₄.

Wherein, if the normal included angle between any one optical path in the strong light emitting area and the environmental medium is equal to θ₁, the normal included angle between any one optical path in the secondary light emitting area and the environmental medium is equal to θ₂, the normal included angle between any one optical path in the weak light emitting area is equal to θ₃ and the normal included angle between any one optical path in the slightly light emitting area is equal to θ₄, then cosθ₁/R₁²≈cosθ2/R₂²≈cosθ3/R₃²≈cosθ₄/R₄².

In a preferred embodiment, the angle θ₁ falls within a range of 0°<θ₁≦30°, the angle θ₂ falls within a range of 30°<θ₂≦45°, the angle θ₃ falls within a range of 45°<θ₃≦60° and the angle θ₄ falls within a range of 60°<θ₄<90°.

In another preferred embodiment, the distance between the rectangular base plate and the light exit surface falls within a range of 0.1 cm-5 cm.

In another preferred embodiment, the reflective micro-structure includes two primary inclined plate structures, and the light emitting diodes disposed opposite to both sides of the rectangular base plate are installed at the middle positions of the rectangular base plate.

In another preferred embodiment, the lateral planar light emitting module further comprises at least one optical lens installed at a light output position of the light emitting diode.

In another preferred embodiment, the light emitting diodes are installed at different angles towards the rectangular base plate.

The effects of the present invention reside on that a lateral planar light emitting module having a rectangular base plate and a plurality of light emitting diodes is provided, and the rectangular base plate has a diagonal falling within a range of 5˜100 cm, and the light emitting diodes are designed with an array arrangement and installed on both opposite sides of the rectangular base plate respectively, such that a light source emitted from the light emitting diodes can be directly projected, or reflected from a reflective micro-structure of the rectangular base plate, and then a light emitting effect with a uniform light intensity is achieved on a light exit surface, wherein the light exit surface opposite to a light projection area with a different intensity produced by the same light emitting diode has an optical path with a different distance and used for substituting a light guide plate used in a conventional backlight module or planar light emitting source to enhance the brightness of an optical film structure, lower the manufacturing cost, and improve the light emitting efficiency effectively.

### BRIEF DESCRIPTION OF THE DRAWINGS

FIG. 1A is a first schematic view, showing a radiation field design theory of a light emitting diode of a lateral planar light emitting module in accordance with the present invention;

FIG. 1B is a second schematic view, showing a radiation field design theory of a light emitting diode of a lateral planar light emitting module in accordance with the present invention;

FIG. 1C is a third schematic view, showing a radiation field design theory of a light emitting diode of a lateral planar light emitting module in accordance with the present invention;

FIG. 2A is a first bottom view of a lateral planar light emitting module in accordance with the present invention;

FIG. 2B is a second bottom view of a lateral planar light emitting module in accordance with the present invention;

FIG. 3 is a first cross-sectional view of a lateral planar light emitting module in accordance with the present invention;

FIG. 4 is a second cross-sectional view of a lateral planar light emitting module in accordance with the present invention;

FIG. 5 is a cross-sectional view of a lateral planar light emitting module with an optical lens in accordance with the present invention; and

FIG. 6 is a cross-sectional view of a light emitting diode of a lateral planar light emitting module projecting lights at different angles towards a rectangular base plate in accordance with the present invention.

### DETAILED DESCRIPTION OF THE PREFERRED EMBODIMENTS

The technical content of the present invention will become apparent by the detailed description of the following embodiments and the illustration of related drawings as follows.

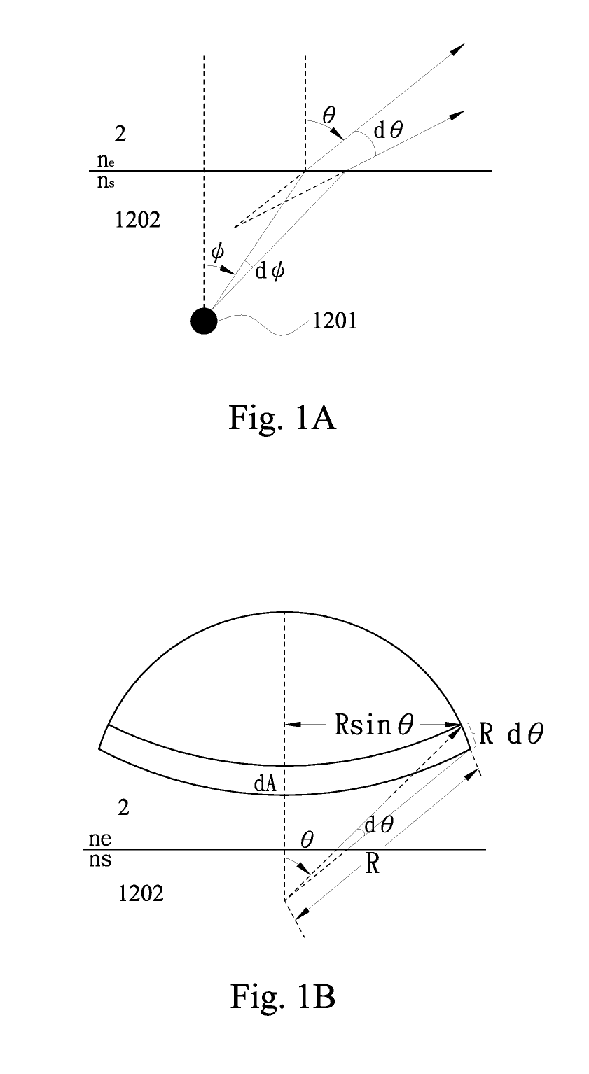

With reference to FIGS. 1A, 1B, 1C, 2A, 2B, and 3 for the first, second and third schematic views showing a radiation field design theory of a light emitting diode of a lateral planar light emitting module in accordance with the present invention and the first, second and third bottom views of the lateral planar light emitting module of the present invention respectively, the lateral planar light emitting module 1 comprises a rectangular base plate 10 and a plurality of light emitting diodes 12, wherein the rectangular base plate 10 has a diagonal falling within a range of 5˜100 cm, and the light emitting diodes 12 are designed with an array arrangement and installed on both opposite sides of the rectangular base plate 10 respectively, such that a light source emitted from the light emitting diodes 12 is projected directly or reflected from at least one reflective micro-structure 101 installed on the rectangular base plate 10 to achieve a light emitting effect with a uniform light intensity on a light exit surface 14. In the lateral planar light emitting module 1 of the present invention provides an important design is required for guiding the light source of the light emitting diodes 12 while considering the light distribution with a uniform light intensity, such that each of the light emitting diodes 12 has its own light distribution area with a different intensity to corresponding different optical paths.

In FIGS. 1A and 1B, the indexes of refraction of the light emitting diodes 12 and an environmental medium 2 are different, so that the radiation field of the light emitting diodes 12 has a pattern of an anisotropic distribution. From the figures, each of the light emitting diodes 12 is comprised of a semiconductor structure 1202 having a dot light source 1201. Assumed that the semiconductor structure 1202 is nₛ, the environmental medium index of refraction is ne, and the interface distance from the dot light source 1201 to the semiconductor structure 1202 and the environmental medium 2 is very short (as shown in FIG. 1B), a normal included angle between the light source path of the light emitting diodes 12 and the environmental medium 2 is equal to φ, and the angle of refraction after the light is refracted from the interface is equal to θ. According to the Snell's law and the condition of φ being very small (or sin φ≈φ), nₛφ=nₑsinθ. According to the law of conservation of energy, the radiation powers at both sides of the interface are substantially equal, or IₛdAₛ=IₑdAₑ, wherein Iₛ is the internal light intensity (W/m²) of the semiconductor structure 1202, Iₑ is the light intensity (W/m²) of the environmental medium 2, dAₛ and dAₑ are areas per unit of the semiconductor structure 1202 and the environmental medium 2. If the radiation field of each of the light emitting diodes 12 is axially symmetrical, dAₑ=2πRsinθRdθ, and dAₛ=2πRsinφRdφ≈2πR²φdφ, so that the environmental medium 2 with a distance of R from the dot light source 1201 has a light intensity Iₑ=(P/4πR²)(nₑ²/nₛ²)cosθ. Obviously, the light intensity distribution relates to cosθ, wherein the maximum intensity occurs when θ=0°, and the light intensity is equal to half of the maximum intensity when θ=60°. In FIG. 1C, a strong light emitting area 121, a secondary light emitting area 122, a weak light emitting area 123, and a slightly light emitting area 124 are formed sequentially in the light intensity distribution area of each of the light emitting diodes 12 and at a normal included angle between each of the light emitting diodes 12 and an environmental medium 2 ranging from 0° to 90°. Preferably, if the normal included angle between any one optical path in the strong light emitting area 121 and the environmental medium 2 is equal to θ₁, the normal included angle between any one optical path in the secondary light emitting area 122 and the environmental medium 2 is equal to θ₂, the normal included angle between any one optical path in the weak light emitting area 123 and the environmental medium 2 is equal to θ₃ and the normal included angle between any one optical path in the slightly light emitting area 124 and the environmental medium 2 is equal to θ₄, then θ₁ falls within a range of 0°<θ₁≦30°, θ₂ falls within a range of 30°<θ₂≦45°, θ₃ falls within a range of 45°<θ₃≦60° and θ₄ falls within a range of 60°<θ₄≦90°. From the description above, the maximum light intensity occurs at a normal included angle between each of the light emitting diodes 12 and an environmental medium 2 equal to 0°; (√3)/2 of the maximum light intensity occurs at the included angle of 30°; (√2)/2 of the maximum light intensity occurs at the included angle of 45°; ½ of the maximum light intensity occurs at the normal included angle of 60° ½; and the intensity approaches zero at the normal included angle of 90°.

With the direct proportion between the light intensity at a certain position of the light emitting diodes 12 and the projection angle, and the inverse proportion between the light intensity at a certain position of the light emitting diodes 12 and the square of distance, a light emitting effect with almost the same light intensity distribution can be achieved in different intensity areas of a single light emitting diode 12 by means of the light reflection from the reflective micro-structure 101 or the direct light projection on the light exit surface 14. For example, a first light output point p1 emitted from the strong light emitting area onto the light exit surface, a second light output point p2 emitted from the secondary light emitting area onto the light exit surface, a third light output point p3 emitted from the weak light emitting area onto the light exit surface, and a fourth light output point p4 emitted from the slightly light emitting area onto the light exit surface have the same distance Rₚ₁, Rₚ₂, Rₚ₃ and Rₚ₄ from the light emitting diode 12 of the same two-dimensional space, then Rₚ₁>Rₚ₂>Rₚ₃>Rₚ₄.

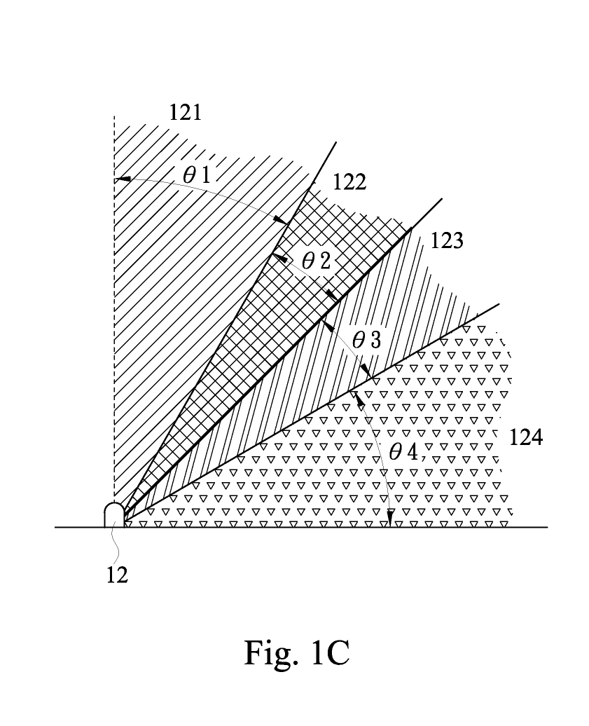

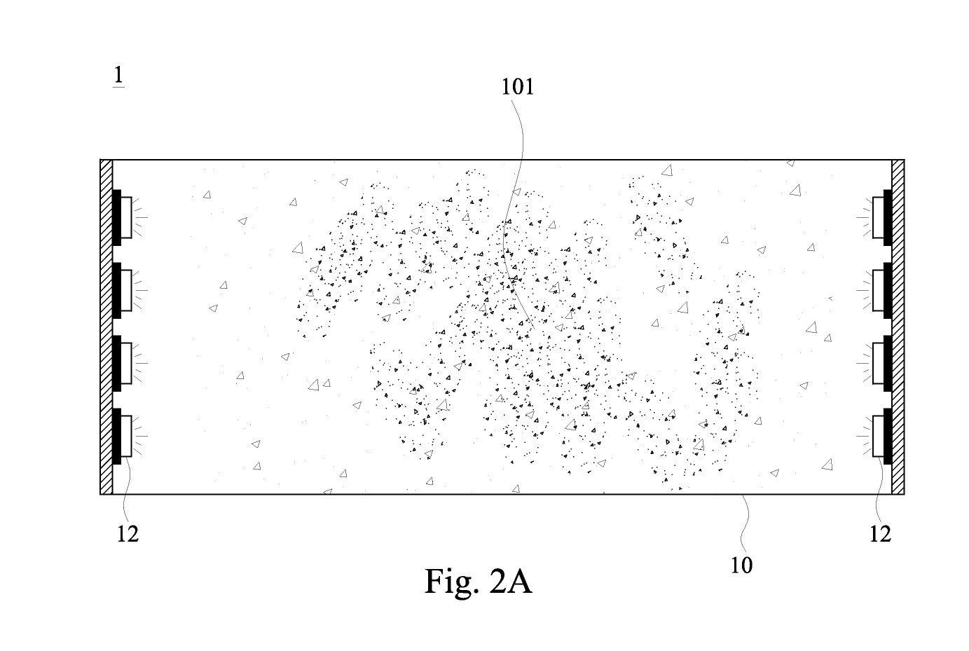

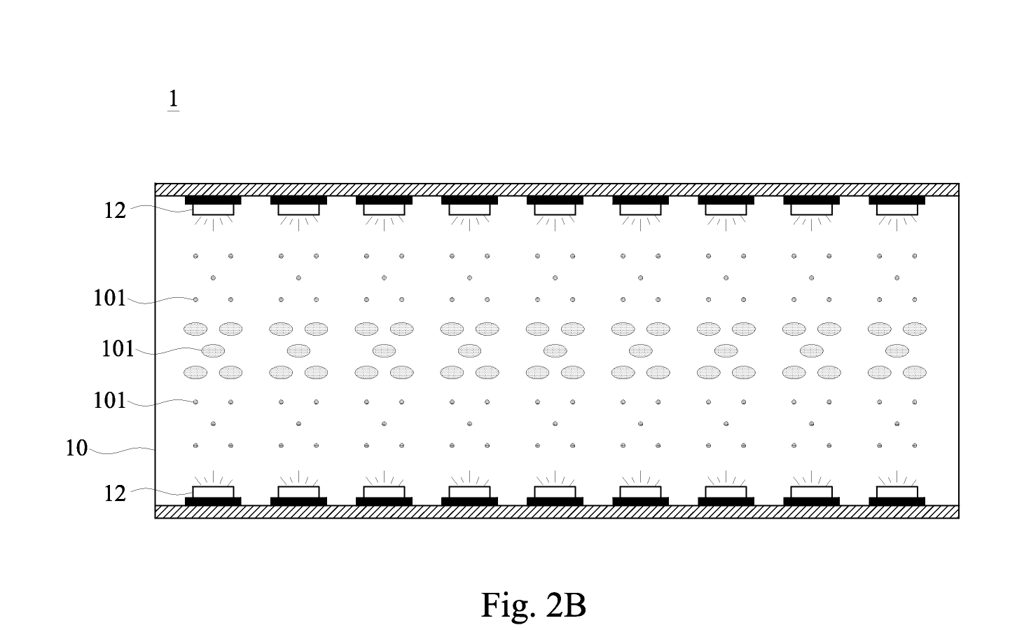

In the designs of different sizes, if the distance between the rectangular base plate 10 and the light exit surface 14 falls within a range of 0.1 cm˜5 cm, the relation cosθ₁/R₁²≈cosθ₂/R₂²≈cosθ₃/R₃²≈cosθ₄/R₄² is adjusted to obtain the best light emitting effect. It is noteworthy to point out that the light emitting diodes 12 as shown in FIG. 2B can be installed on two opposite long sides of the rectangular base plate 10 respectively, and the structural design of the reflective micro-structures 101 can be designed as larger or smaller orderly arranged protruding structures according to the distance from the light emitting diodes 12. Such design is intended for reflecting the light source of the light emitting diodes 12 with different angles from the reflective micro-structure 101, such that the reflection from an area with a stronger intensity of the light source will not increase the optical path too much, and the area with a weaker intensity of the light source can maintain substantially the same output light intensity at the light exit surface 14. In FIG. 3, the reflective micro-structure 101 includes two primary inclined plate structures 1011, and the two primary inclined plate structures 1011 are light emitting diodes 12 disposed opposite to both sides of the rectangular base plate 10 respectively and installed at the middle positions of the rectangular base plate 10. In the figure, the height and inclination for installing the two primary inclined plate structures 1011 is determined by the distance from the light emitting diodes 12 and the aforementioned relation. Preferably, the two primary inclined plate structures 1011 are light emitting diodes 12 arranged in an array on one of the corresponding sides only. Therefore, the light source path can be controlled at the reflection position of the light exit surface 14 effectively. Since the distances from the rectangular base plate 10 and the light exit surface 14 are different, the height and inclination of the two primary inclined plate structures 1011 will be determined by adjusting the relation of cosθ₁/R₁²≈cosθ₂/R₂²≈cosθ₃/R₃²≈cosθ₄/R₄². with reference to FIG. 4 for a second cross-sectional view of a lateral planar light emitting module in accordance with the present invention, the optical path of each of the light emitting diodes 12 can be adjusted flexibly at the position of the light exit surface 14, and adjacent sides of the two primary inclined plate structures 1011 have two secondary inclined plate structures 1012 respectively for fixing each light emitting area with a fixed output light angle on the light exit surface 14 to form different optical paths, so as to adjust the magnitude and position of the light intensity of the output light. It is noteworthy to point out that the two primary inclined plate structures 1011 and the two secondary inclined plate structures 1012 can be designed with a non-flat plate surface for changing the angle of the optical path significantly and effectively without increasing the optical path too much, so as to maintain the performance of the light intensity.

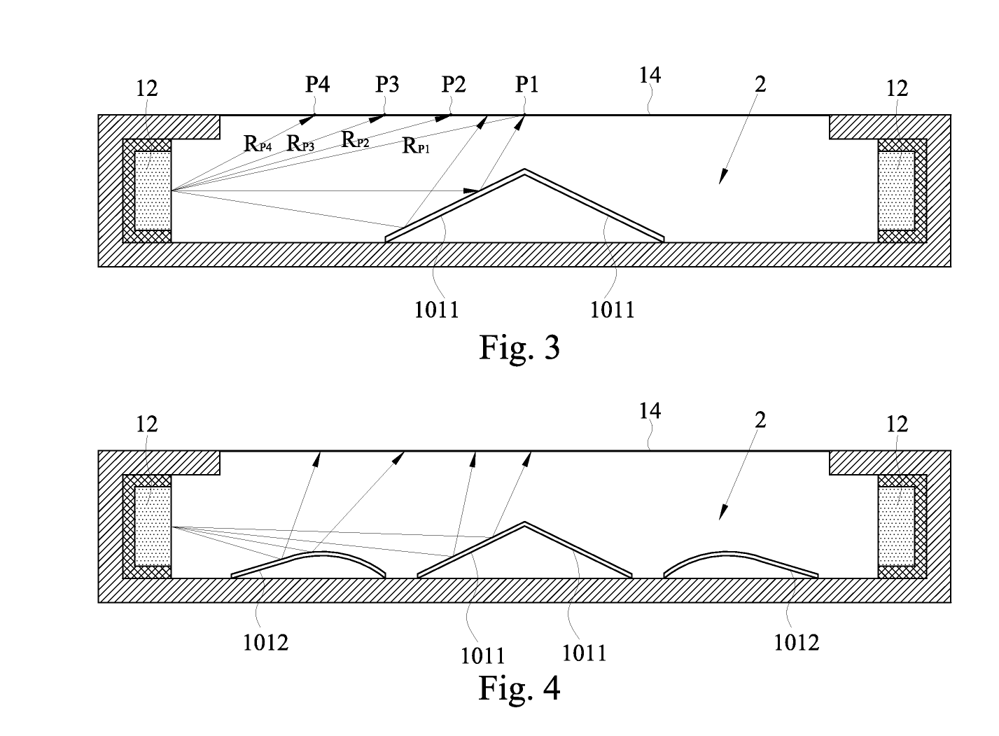

With reference to FIG. 5 for a cross-sectional view of a lateral planar light emitting module with an optical lens in accordance with the present invention, the structural design of the foregoing preferred embodiment adjusts the light intensity of the output light when the output position and the length of the optical length in the light emitting area of the light emitting diodes 12 are fixed through the reflective micro-structure 101. In this preferred embodiment, an optical lens 16 is provided for changing the range of the light emitting area of the light emitting diodes 12 directly, and two adjustment factors are used for adjusting the position and the intensity of the output light at the light exit surface 14. In the figure, if the present invention is applied in a flat plate illumination, the central position of the light exit surface 14 is emphasized, so that the optical lens 16 can reflect all lights projected onto the reflective micro-structure 101 for the areas with the light intensity grater than half of the maximum intensity, so that a larger range of the light intensity can be used effectively.

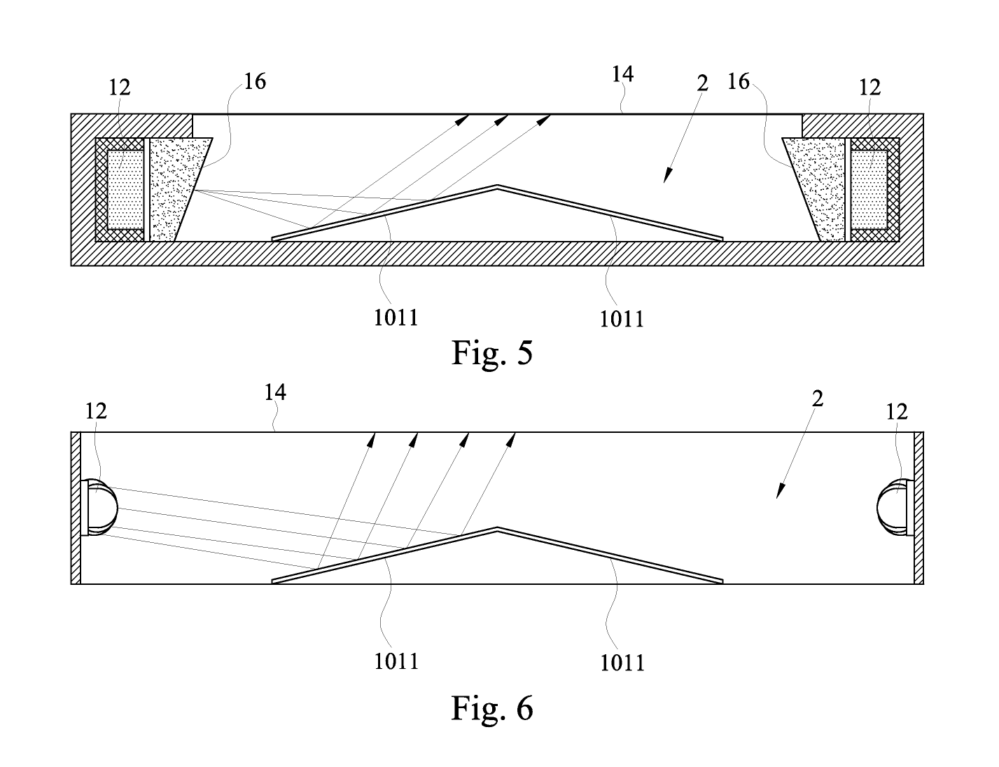

With reference to FIG. 6 for a cross-sectional view of a light emitting diode of a lateral planar light emitting module projecting lights at different angles towards a rectangular base plate in accordance with the present invention, the light emitting diodes 12 of the present invention are arranged in an array, so that the radiation field of each of the light emitting diodes 12 at the light exit surface 14 may have a superimposition effect. Therefore, the edges (such as the frame of the display) of the rectangular base plate 10 have a less superimposition effect than the central area of the rectangular base plate 10. To adjust the uniformity of the light intensity at the edges of the rectangular base plate 10 and other positions of the light exit surface 14, the light emitting diodes 12 can be installed at a different angle with respect to the rectangular base plate 10, such that the light emitting areas of the light emitting diodes 12 can be used effectively.

In summation of the description of the foregoing preferred embodiments, the effects of the present invention reside on that the lateral planar light emitting module having the rectangular base plate and the plurality of light emitting diodes is provided, and the rectangular base plate has a diagonal falling within a range of 5˜100 cm, and the light emitting diodes are designed with an array arrangement and installed on both opposite sides of the rectangular base plate respectively, such that a light source emitted from the light emitting diodes can be directly projected, or reflected from a reflective micro-structure of the rectangular base plate, and then a light emitting effect with a uniform light intensity is achieved on a light exit surface, wherein the light exit surface opposite to a light projection area with a different intensity produced by the same light emitting diode has an optical path with a different distance and used for substituting a light guide plate used in a conventional backlight module or planar light emitting source to enhance the brightness of an optical film structure, lower the manufacturing cost, and improve the light emitting efficiency effectively.

What is claimed is:

1. A lateral planar light emitting module, comprising a rectangular base plate and a plurality of light emitting diodes, the rectangular base plate having a diagonal within a range of 5˜100 cm, the light emitting diodes being disposed in array arrangement on opposite sides of the rectangular base plate respectively, to project light emitted from the light emitting diodes directly or reflected from the rectangular base plate, for a uniform light intensity distribution at a light exit surface, wherein the lateral planar light emitting module is characterized in that the rectangular base plate includes a plurality of reflective micro-structures formed thereon, the reflective micro-structures include a plurality of primary inclined plate structures that are at the middle positions of the rectangular base plate, and a plurality of secondary inclined plate structures that are on the same plane and opposite sides of the primary inclined plate structures.

2. The lateral planar light emitting module of claim 1, wherein the primary inclined plate structures have a horizontal height greater than a horizontal height of the secondary inclined plate structures.

3. The lateral planar light emitting module of claim 1, wherein the primary inclined plate structures have an inclined slope greater than an inclined slope of the secondary inclined plate structures.

4. The lateral planar light emitting module of claim 1, wherein the rectangular base plate and the light exit surface have a distance falling within a range of 0.1 cm˜5 cm apart from each other.

5. The lateral planar light emitting module of claim 1, further comprising at least one optical lens installed at a light output position of the light emitting diode.

6. The lateral planar light emitting module of claim 2, further comprising at least one optical lens installed at a light output position of the light emitting diode.

7. The lateral planar light emitting module of claim 3, further comprising at least one optical lens installed at a light output position of the light emitting diode.

8. The lateral planar light emitting module of claim 4, further comprising at least one optical lens installed at a light output position of the light emitting diode.
